(19) United States
(12) Patent Application Publication
(10) Pub. No.: US 2009/0016800 A1
(43) Pub. Date: Jan. 15, 2009

(54) Pen with operable clip

(76) Inventor: Sushanta Barthakur, Guwahati (IN)

Correspondence Address: SUSHANTA BARTHAKUR, B-3 Karunamoyee Apt, M.C. Road, Uzanbazar, Guwahati, 781001, IN

(21) Appl. No.: 12/220,463

(22) Filed: Jul. 25, 2008

Related U.S. Application Data
(60) Provisional application No. 60/963,655, filed on Aug. 7, 2007.

(30) Foreign Application Priority Data
Dec. 20, 2006 (IN) 1386/KOL/2006

(51) Int. Cl. B43K 5/16

(52) U.S. Cl. 401/104

(57) ABSTRACT

There are records of making pens with operable clip. Most such pens provide less entry passage length for pocket flap to enter through the gap between the clip and the body of the pen or cap, while others provide a minimal lever arm length, very less thumb keeping space and minimal mechanical advantage. The pen with operable clip according to this invention provide a full effective clip length entry passage for flap of pocket or other anchoring object to enter through the gap between the clip and the body of the pen; simultaneously with adequate or improved mechanical advantage obtainable provision and provision to offer adequate space for thumb support. Besides, provision of interlocking facility of the clip with the pocket flap, production co-operating hinge and spring eliminated arrangements, and its applicability in different hand held implements and casings are added features of this invention.

### FIELD OF INVENTION

This invention relates to the field of improvement of writing instrument, particularly pen and pen like writing instrument, more particularly relates to improvement of clipping devise of pen and pen like writing instrument. However, this invention also cover the field of improvement of clipping devise of hand held implements, particularly slender formed hand held implements and slender formed casings that can be anchored and carried conveniently in a pocket or other anchoring object.

### BACKGROUND OF INVENTION

Many attempts have been made for years to make a good pen with a convenient clipping device.

The word “pen” used here is to mean the pen like writing instruments like fountain pen (ink pen), ball pen, drafter's inking pen, sketch pen, micro-fine tipped pen, marker pen, pencil pen, pencil and like, and particularly which are incorporated with a clipping devise or which can be provided with a clipping devise.

Pens are used for writing, drafting, marking, and doing art work and like kind of work in different ways. Clipping devise helps in clipping a pen to the wearing cloth, usually to the flap of pocket and carrying bag and like. A pen is a hollow cylindrical formed body with a writing provision incorporated end and a non-writing end. Capped pens are provided with one end closed and one end open hollow cylindrical formed caps to cover the writing end of pen during the non-use period. The uncapped pens are not provided with caps. Some of the uncapped pens have clicking button and some have turning provision to draw-in and push out the writing tip. Clips are incorporated to the close end side of the caps in case of capped pens and to the non-writing end side of the body or barrel, in case of uncapped pens.

Some of the different kinds of clipping arrangements of pens made so far are described below.

1. Spring forced, usually self-spring forced strong gripping pressure imposed clipping arrangement.

Pens with clips made according to this arrangement are little bit hard to slide in and slide out to and from the pocket. The pocket stitches and linings often hinder its sliding move. During the process the pocket flap also comes up and goes down along with the pen to some extent. Besides, both the hands are to be used often; one hand to hold the pocket flap tightly and the other to slide in and slide out to and from the pocket. Such arrangements of clipping are inconvenient and uncomfortable in these points of views.

2. Self spring forced light gripping pressure imposed clips with contacting projections made to the clips or to the body of the pen (or pen cap) or to both as in case of most plastic made capped pens and uncapped pens.

In these kinds of clipping arrangements, projections are made to the clip usually at the location of clipping head to create resistance, while on the other hand they are to be made smooth for easy slide in and slide out to and from the pocket. These kinds of clipping arrangements have disadvantages that the clipped pens easily come out from the pocket, particularly along with other material, when other material in the pocket are taken out. During the process such pens often fall down from pocket and occasionally the pens are getting lost. Besides, in some occasion, light upward thrust caused due to touch of self-hand or due to touch of other persons or material, particularly in crowded gathering and in buses and trains the pens with such kind of clipping go up and fall down. Therefore, these kinds of clipping arrangements are also inconvenient.

Both the above stated kinds of clipping arrangements have a common disadvantage that in using pens with such kinds of clipping arrangement, it is difficult to press in and pull out the pens to and from thick pocket flap, like coat pocket.

To solve these problems, pen with an operable clip is a solution; that is, a pen with an arrangement by which the clipping head of its clip can be lifted up through a mechanical means by finger operation and can be allowed to fall down by an incorporated spring imposed force, upon releasing the finger.

There are numbers of patents and prior art associated with pen clip where operation of the pen clip is desired. U.S. Pat. No. 276,512 to J. F. Webstar, U.S. Pat. No. 863,029 to J. A. Holland, U.S. Pat. No. 883,767 to A. K. Watts, U.S. Pat. No. 1,339,359 to J. Kritikson, U.S. Pat. No. 1,339,359 to G. D. Gorman, U.S. Pat. No. 5,361,459 to Hyvonen et al, U.S. Pat. No. 5,678,281 to Kamp et al., U.S. Pat. No. 6,499,196 to Mittersinker et al, and U.S. Pat. No. 6,685,374 to Cetera are examples of such patent holders. In most of these, the length of entry passage for flap of pocket or other anchoring object through the gap between the clip and the body of the pen is limited; which is only a part of the total effective length of the clip, taking the effective length of a clip as the distance between the clipping head and the other end of the clip, without taking into account the distance portion through which it is connected to the body of the pen.

It is therefore an object of this invention to make a pen with operable clip that offer a full length of entry passage for flap between the clip and the body of the pen, to the extent almost equal to full effective length of the clip, with provisions to avail simultaneously improved mechanical advantage and adequate space for placing thumb, which is required at the diametrically opposite side of the operating end to offer convenience in easy and comfortable operation.

It is therefore an another object of this invention to make a pen with operable clip that offer facility of interlocking the clip with the pocket flap as an added feature.

It is therefore still an another object of this invention to make a pen with operable clip which is production co-operating.

### SUMMARY OF THE INVENTION

These problems are overcome by the present invention, which provides a pen with an operable clipping device comprising a mechanical advantage obtainable and conveniently operable spring force imposed movable arm, incorporated with a clipping head at one end and the other end is usable as operating end, and it is pivotally incorporated over a cantilever formed fixed arm, and the fixed arm is further incorporated to the cap or body of the pen in a fixed way, arranged in a manner so that at normal clipping state the clipping head imposes sufficient gripping pressure. By pressing the operating end of the movable arm the clipping head can be lifted up and gripping pressure can be released and the pen can easily be inserted in and taken out to and from the pocket. As an added feature of this invention a press ejecting pointed hiding pin is incorporated to the clipping head by making the pin movable through a bore and hide when the clipping head surface is not under pressure and the pin ejects out through the clipping head when the clipping head surface is under pressure, that is at its clipping state, to facilitate interlocking the pen with the flap of pocket by the pin.

“Pen with operable clip” comprising a pen and an operable clipping devise incorporated to it; the pen is a hollow cylindrical formed body with a writing provision at one of its ends and the other end is a non-writing end; one kind of pen is provided with one end closed and one end open hollow cylindrical formed cap and the other kind of pen is not provided with cap; clipping devices are incorporated to the close end side of caps in case of capped pens and to the barrel or body of the pens at near its non writing end side in case of uncapped pens; characterized in that the clips according to this invention are made with a provision to provide full entry passage length for flaps of pocket equal to the effective length of the clip, simultaneously to impose adequate gripping pressure, to offer improved mechanical advantage and to provide adequate space for placing thumb conveniently to the of the end of the pen or cap to support finger operation. The arrangement thus made comprises assembly of two arms, of which one is a fixed arm over which the other movable arm is pivotally or equivalent way incorporated at a point or location at a distance gap from the fixed point, the operating end is elastically biased from the fixed end of the fixed arm through a gap to exert pressure through the clipping head, an almost uniform gap is maintained between the fixed arm and the body of the pen up to the fixed point where fixed arm is linked to the unit body, so that, that by applying finger pressure at the provided end of the movable arm, the gripping pressure can be released to make it convenient and easy to slide in and slide out the pen to and from the flap of pocket or carrying bag or like; the fixed arm is fixed by securing one of its ends to the close end side of the cap in case of capped pens, and to the non-writing end side of pen in case of uncapped pens maintaining a gap with the surface of the cap or pen, and is incorporated with a hinging provision or equivalent provision at its upper side at a distance from the fixed end, and for convenience of hinging, the movable arm or to link the movable arm in an equivalent way to create a mechanical advantage obtainable lever arm; the movable arm is made movable up and down about the axis of the hinge or equivalent provision and it is hinged or linked at the provision made in the fixed arm; the assembly is made in a manner so that the clipping head incorporated at the movable end is at a position beyond the free end of the fixed arm and that the other end of the movable arm rests near the close end of cap or near the non-writing end and is usable as operating end; a spring arrangement or a arrangement for elastically biasing the operating end and the fixed end is incorporated to the assembly, so that in the normal state it imposes an up-thrust to the operating end or down thrust to the clipping head and thereby imposes a gripping pressure through the projected pressuring or clipping head, while by pressing the operating arm the clipping head could be lifted up and the gripping pressure could be released; it also characterized in one of its another form that a safety step measured pointed pin is incorporated making the pin movable through a bore and hide when the clipping head surface is not under pressure and the pin projects out through the clipping head when the clipping head surface is under pressure, that is at its clipping state, to facilitate interlocking the pen with the flap of pocket by the pin.

Different forms of pen with operable clips based on different incorporations are as follows:—

1. Based on kind of clipping head, in one form the clipping head is made solid or made sheet metal formed.

2. Based on the kind of clipping head, in an another form a pointed pin is incorporated to the pressing end of the movable arm which further arranged to pierce through the pressuring head or clipping head through a compressible assembly, a co-operating hole or groove is made to the cap or pen body or barrel and arranged so that in normal or under pressed state of the pressing head, the point of the said pin project out through the contact surface of the clipping head and pierce through the flap of pocket or other anchoring objects and like and gets interlocked for a firm clipping, while during pressure released state the pin tip hide inside the clipping head first before it is lifted up as a safety measure.

3. Based on the kind of clipping head, in a still another form, the pressure face of the clipping head is made with wide area or roughened, or friction creating material incorporated like rubber incorporated and like to make the clip slide resisting, to prevent easy fall out of the pen; as for the kind of pen with operable clip, area minimizing and smoothening of the clipping face is not a must.

4. Based on spring shape kind, in one form one leg extended “U” shaped spring is incorporated and the spring is secured to the free end of the fixed arm using “U” curve of the spring, while the extended leg portion is further shaped to impose up-thrust at near the operating end of the lever arm and thereby to impose downward pressure at the clipping end. In an another form “U” shaped spring is incorporated by securing its one leg to the free end of the fixed arm, and the other leg to the movable arm directing the legs towards free end and clipping end and imposing downward pressure at the clipping end.

5. Based on spring shape kind, in an another form “S” shaped spring is incorporated and the spring is secured to the free end of the fixed arm using one of the curves, while the other curve part is shaped as needed to impose downward pressure at the pressing end;

6. Based on kind of hinging or kind of equivalent incorporation, in one form provisions are made for hinging the movable arm to the fixed arm (i) by headed pin, providing holes to the arms or its extensions and using co-operating pins, or (ii) by providing outward projections to the fixed arm and inward grooves to the movable arm or vice-versa in alignment or (iii) by making holes to the arms in alignment and using solid or hollow rivets, (iv) by providing holes to the arms or its extensions and using co-operating spring bar.

7. Based on kind of hinging or kind of equivalent incorporation, in an another form instead of hinge an equivalent arrangement is created using “S” shaped or “U” shaped kind of springs and shaping them further to impose downward pressure to the pressing end and firmly securing the springs to the fixed arm and to the movable arm; in this arrangement the movable arm could be moved up and down about an unseen hinge or axis and physical hinge is not required.

8. Based on incorporation equivalent to pivoting arrangement and incorporation equivalent to elastically biasing arrangement like spring in a combined way, the fixed arm and the movable arm is made with rigidity improving cross sections and linking the fixed arm and the movable arm by a link portion at a positions to effect an equivalent pivoting position or location; the link portion is made with rigidity reducing or flexibility improving cross section, to make the arrangement work as equivalent to incorporation of pivoting and elastically biasing arrangement in a combine way.

Different suitable material may be used for making different parts of the pen with operable clip such as metal for nib and refill tip; hard rubber or celluloid or vulcanite for feed; nylon or metal or plastic or like for refill; plastic for cartridge and any one or more of material namely plastic, metal, fiber, rubber and like for the rest of the pen parts. For making the parts of the operable clip different suitable materials are used as used in cap and pen body or barrel like metal, plastic, fiber and like while for its pressure imposing springs and for the pointed pin appropriate metal and other relevant property bearing material may be used. Plastic of appropriate kind, quality, cross section and size may also serve as spring in an equivalent way. As regards kinds of the said pressure imposing springs flat springs and flat corrugated springs are workable, while other kind of springs like coil spring, shaped wire spring and like may also be used.

To assist with understanding the invention, reference will now be made to the accompanying drawings, which show one example of the invention and few of its other forms and features.

### BRIEF DESCRIPTION OF THE DRAWING

FIG. 1 shows plan view of a capped pen with operable clip according to this invention.

FIG. 2 shows view of sectional elevation of the pen with operable clipping device shown in FIG. 1, section taken vertically through the axis.

FIG. 3. shows an uncapped pen with operable clipping device, showing sectional elevation of the clip and a small adjacent portion.

FIG. 4. shows enlarged view of sectional elevation of a clip and its small adjacent portion of a capped pen with operable clip with provision to offer interlocking facility, showing the pointed pin as incorporated to the pressure end.

FIG. 5. shows a sectional elevation of clipping head part of a pen with operable clip incorporated with a pointed pin with a provision of self-part arranged to act as spring.

FIG. 6. shows the hinging arrangement in which the movable arm of the clip is hinged to the fixed arm; this also shows the arrangement of placing the movable arm inside the fixed arm.

FIG. 7 shows the arrangement of hinging in which the movable arm of the clip is hinged to the fixed arm with hinge made by projections and grooves in alignment; this also shows the arrangement of placing the movable arm covering the fixed arm.

FIG. 8. shows three-dimensional view of a pen with operable clip in which an “S” formed spring is used and the clip is made operable without incorporation of hinge.

FIG. 9 shows sectional view of a pen cap with operable clip in which a “U” formed spring is used and the clip is made operable without incorporation of hinge.

FIG. 10 shows a clip part wherein the fixed arm and the movable arm is linked by a linking portion with appropriate cross sections to effect the incorporations act equivalent manner like incorporation of a pivoting arrangement and incorporation of an elastically biasing spring arrangement in a combined way.

FIG. 11 shows view of cross section of operating arm, section taken at P Q in FIG. 10.

FIG. 12 shows view of cross section of the link portion, section taken at M N in FIG. 10

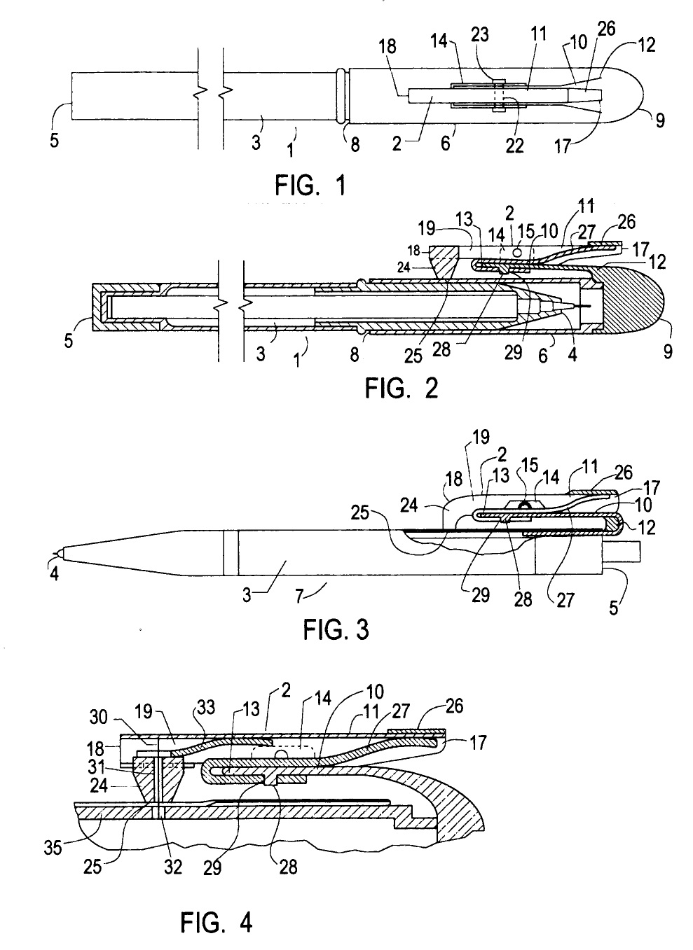

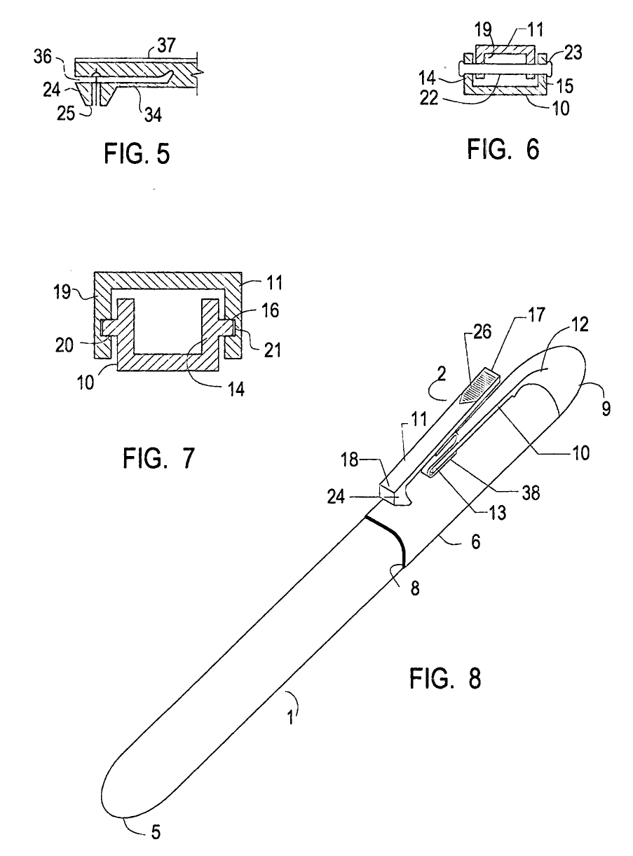

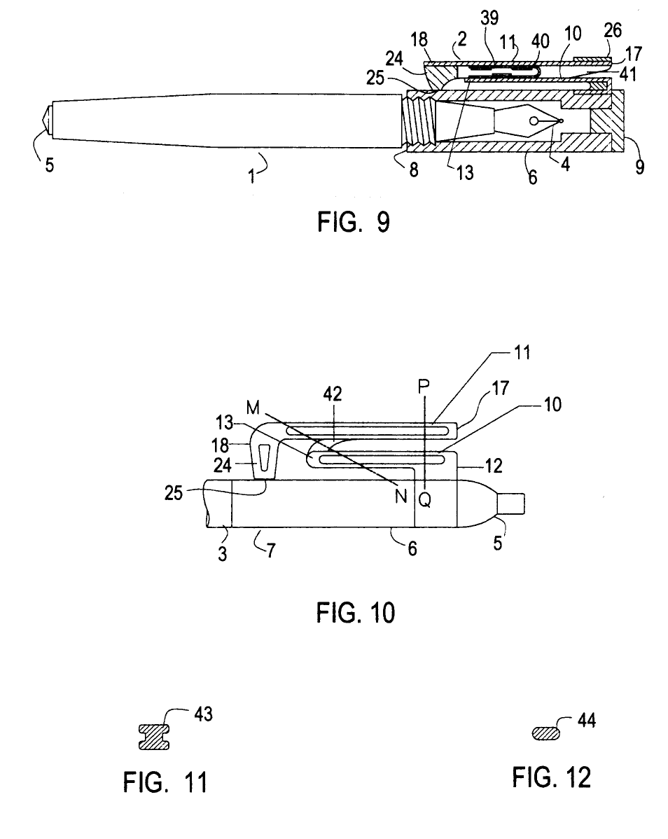

The invention would be discussed now in more detail with reference to the drawings.

### DETAILED DESCRIPTION OF PREFERRED EMBODIMENT

A pen with operable clip comprising a pen 1 to which an operable clip 2 is incorporated which helps to release the gripping pressure of the clip when needed, particularly at the time of inserting the pen in the pocket and in taking out from it.

The operable clip is an assembly of miniature arms with needful shape, incorporations and parts, arranged to make it mechanical advantage obtainable and conveniently operable.

A pen is a slender form assembly of a hollow cylindrical formed body or barrel 3 with a writing provision incorporated end or writing end 4 and non writing end 5 with needful incorporations. One kind of pen 1 is provided with cap 6 and another kind of pen 7 is not provided with cap. Let us call these pens as capped pen and uncapped pen respectively. A cap has an open end 8 and a closed end 9. The operable clip comprises a fixed arm 10 and a movable arm 11. One end 12 of the fixed arm is secured at the close end side of the cap in case of the capped pen, or at the non-writing end of the pen in case of the uncapped pen. Let us call the end 12 as fixed end and the other end 13 as free end. The fixed arm is made inverted ‘L’ or tilted ‘U’ shaped form or a cantilever form of arrangement and secured to the pen cap or to the non-writing end in a manner that the fixed arm created in this a way maintains needful distance from the surface of the pen or cap, so that the pen can freely be inserted to the pocket through the gap. The fixed arm is further provided with upright collars 14 at its sides and provided with an arrangement like aligned holes 15, or projections 16 in alignment or equivalent arrangement at a distance from the fixed end to co-operate incorporation of the movable arm pivotally over the fixed arm by hinging or by equivalent arrangement.

The movable arm has an operating end 17 and a pressure-imposing end say pressure end or clipping end 18. It is further provided with collars 19 or equivalent co-operating arrangement like holes 20 or grooves 21 in alignment or like and the movable arm is hinged to the fixed arm using headed pin 22 with head 23 or using equivalent other provisions. The movable arm at its pressure end is provided with a formed body 24; let us call it as clipping head with a contacting pressure face 25. The area of the contacting face may be made small to more in size or made frictional resistance creating as needed. The operating end is provided with at its upper side a finger rest 26, pressing at which the clip could be operated and the pressure end could be lifted up. To retain the operating end upward and the pressure end downward under pressure in normal state, a spring, preferably an one leg extended ‘U’ shaped spring 27 is incorporated to the fixed arm (or may be incorporated to the movable arm) by bending round the free end 13 and locking the same to the fixed arm by making a projection 28 to the fixed arm and a co-operating slit 29 to the spring or by tabbing or by any appropriate method.

Different forms of pen with operable clips based on different incorporations are as follows:—

1. Based on the kind of clipping head, in one form the clipping head 24 is made solid or made by bending the pressure end of the movable arm or by incorporating bending strips.

2. Based on kind of clipping head, in an another form a Pointed pin 30 like needle is incorporated to the pressure end almost perpendicularly, directing the point towards pen surface or axis of the pen; a co-operating bore 31 is made to the clipping head 24 through which the pin 30 is kept movably inserted and the head is constrained to move up and down along the pin through a small distance. A co-operating hole 32 (or groove) is made to the cap or barrel and a downward light pressure imposing spring like fork ended spring 33, (or sponge) or creating a spring action imposing branch 34 or like is provided to the pressure head side. The downward pressure-imposing member is relatively light force imposing in comparison to the effective force of the spring 27 at the pressure end and is incorporated in such a way that normally or under pressed state of the clipping head, the point of the said pin project out through the contact surface of the clipping head and pierce through the flap 35 of pocket (or other clipping material) and gets interlocked with the flap of pocket for a still better and firm clipping, while during pressure released state the pin tip hide inside the clipping head first before the clipping head lift up. To improve the rigidity of the arms, collars 37 or ribs are incorporated to the arms and to the arm part of branched arm.

1. Based on spring shape kind, in one form one Leg extended “U” shaped spring 27 is incorporated and the spring is secured to the free end of the fixed arm using “U” curve of the spring curving round the end, while the extended leg portion is further shaped to impose up-thrust at the operating end 17 of the lever arm.

2. Based on spring shape kind, in another Form “S” shaped spring 38 is incorporated. The spring is secured to the free end of the fixed arm curving round one of its curves round the end, while the other curve part is shaped as needed and secured to the movable arm by tabbing or other means, directing the pressure end to impose downward pressure at the pressure end.

3. Based on the kind of hinging or kind of equivalent incorporation, in one form provisions are made for hinging the movable arm to the fixed arm (i) by headed pin 22 and co-operating holes 15 and 20, or (ii) by providing outward projections 16 to the fixed arm and inward grooves 21 to the movable arm or vice-versa in alignment.

4. Based on the kind of hinging or kind of equivalent incorporation, in an another form, instead of hinge an equivalent arrangement is created by using “S” shaped spring 38 or “U” shaped spring 39 and shaping them further to impose downward pressure to the pressuring end. The spring is secured to the arms by tabbing using tabs 40 or tabbing by bending the edges of the arm itself and/or by using other appropriate method and is secured firmly in a manner so that the movable arm move almost in the plane containing the pen axis and the axis of the fixed arm. The movable arm is incorporated with side extensions, or extended along its boundary edges with collars 41 towards downward direction to co-operate hinging and to cover or encase the mechanism inside and to act as casing of the operable clip. In this arrangement the operating end of the movable arm could be moved up and down about an unseen hinge or unseen hinge axes, and thus this form of pen with operable clip is operable without hinge.

5. Based on incorporation equivalent to pivoting arrangement and incorporation equivalent to spring to act as elastically biasing arrangement in a combined way, the fixed arm and the movable arm is made with rigidity improving cross section like “I” section 43 or channel “[” section and like and linking the fixed arm and the movable arm by a link portion 42 at positions to effect an equivalent pivoting position or location, the link portion is made with rigidity reducing or flexibility improving cross section like corner rounded off rectangular section 45, or “O” section or elliptical section and like; even “I” section and like with reduced cross sectional area would serve to reduce rigidity, or to improve flexibility. This arrangement and arrangements close to this arrangement are production co-operating, particularly for its molding and component minimizing features.

By the use of the pens with operable clipping device, the user can insert, clip and take out the pens to and from their pockets freely without any hindrance or resistance. It is easy to use the clips of such pens equally in case of even thick cloth made pockets like pocket of coats. Besides, clips of such pens can be made to grip the flap of pockets with sufficient gripping force, which prevent easy falling out of the pens from the pockets. Clipping of such pens can be used by single hand operation. Press ejecting pin incorporated form of such pens can be made to interlock the pens with the pockets.

What is claimed is:

1. A slender formed unit body with needful assemblies that can be anchored and carried conveniently in a pocket or other such anchoring support containing a flap, or equivalent; at an appropriate part and position of the unit body there is incorporated a clip which constitute a unit body with clipping head incorporated clip, like pen with a clip and like, other hand held implement with clip and like, characterized in that for convenience of lifting up and letting down the clipping head conveniently and comfortably availing enhanced mechanical advantage without interfering or shortening the pocket flap passage length through the gap between the body and the clip and vice versa, the clip is made operable as assembly of at least a fixed arm, one end of which is secured or linked in a fixed way at near an appropriate end of the unit body, this end is a fixed end; the fixed arm extends through a limited distance directing towards the other end of the unit body maintaining a gap from the unit body, its other end is a free end; with needful components there is incorporated at least one movable arm over the fixed arm pivotally by means of a pivoting arrangement or an equivalent arrangement, one end of the movable arm is meant for use as operating end, which is set almost over the fixed end of the fixed arm with an elastically biased vertical gap, and its other end is the clipping end; the clipping end is incorporated with a gripping surface incorporated clipping head, set in the direction of the free end with an extension through a short distance beyond the free end; the position or location of pivot or its equivalent is at distance gaps from fixed end and operating end; a biasing arrangement is incorporated to the clip assembly elastically biasing the fixed end and the operating end using elastic material and arrangement like spring arrangement or equivalent and there by to exert gripping or clipping pressure through the clipping head during non operating state and to auto let down of the clipping head upon releasing the pressure from the operating end; in an another variant of the invention to facilitate interlocking the pen with the pocket flap a pointed pin with press ejecting arrangement is incorporated at the clipping end.

2. A slender formed unit body as stated in claim 1 comprises a body like capped body with cap like capped pen and like, uncapped body like uncapped pen and like, capped hand held implement, uncapped hand held implement like uncapped screw driver and like, encased body like casing of the encased spectacle and like which all constitute a unit body, and incorporated clips to its appropriate part and position means, clip incorporated at near the non working end of the body in case of uncapped pen and like, clip incorporated at near the close end of cap in case of capped body, clip incorporated to the casing at near an end of casing, like casing of encased spectacle and like and this constitute an unit body with clip, at least capped and uncapped body comprises needful components and assembly to make a working provision at least at one of its ends, like writing provision in case of writing instrument like pen and like, characterized in that the clip incorporated to it according to this invention comprises assembly of two arms, of which one is a fixed arm over which the other movable arm is pivotally or equivalent way incorporated at a point or location at distance gap from the fixed point, the operating end is elastically biased from the fixed end of the fixed arm through a gap to exert pressure through the clipping head, an almost uniform gap is maintained between the fixed arm and the unit body up to the fixed point where fixed arm is linked to the unit body.

3. A slender formed unit body stated in claim 1 and 2 is a single or assembled body with a provision of writing arrangement that can be made available at least at one end of the elongated formed body, like writing instrument like pen, like fountain pen, ball pen, marker, sketch pen, pencil and like, capped and uncapped such writing instrument, such writing instrument like pen with clip characterized in that the clip incorporated to it according to this invention comprises assembly of two arms, of which one is a fixed arm over which the other movable arm is pivotally or equivalent way incorporated at a point or location at distance gap from the fixed point, the operating end is elastically biased from the fixed end of the fixed arm through a gap to exert pressure through the clipping head, an almost uniform gap is maintained between the fixed arm and the unit body up to the fixed point where fixed arm is linked to the unit body.

4. A slender formed unit body stated in claim 1 and 2 is single or assembled body like hand held implement, like tool like screw driver, scale, electric current tester, blood sugar tester and like and casing like spectacle casing and like, capped and uncapped such body with clip, characterized in that the clip incorporated to it according to this invention comprises assembly of two arms, of which one is a fixed arm over which the other movable arm is pivotally or equivalent way incorporated at a point or, location at distance gap from the fixed point, the operating end is elastically biased from the fixed end of the fixed arm through a gap to exert pressure through the clipping head, an almost uniform gap is maintained between the fixed arm and the slender formed unit body up to the fixed point where fixed arm is linked to the unit body.

5. A slender formed unit body stated in claim 1, 2, 3 and 4 according to this invention wherein an almost uniform clear gap space is maintained between the fixed arm and the elongated formed unit body, more particularly, an almost uniform face to face clear gap space is maintained between the fixed arm and the elongated formed body of the body part to which the fixed arm is incorporated, the stated gap space is maintained through full distance almost up to the point where the fixed arm is linked to the elongated formed body like pen and like for easy and full insert of pocket flap through the stated gap space and vice versa.

6. A slender formed unit body stated in claim 1 to 5 according to this invention wherein the end of the fixed arm is secured or linked in a fixed way at near an appropriate end, where the space say “d” of the of the fixed way linking point from the appropriate end or nearest end of the unit body like pen is usually within a distance length that maintained in the conventional otherwise equivalent kind of such unit body like pen; the pivoting point or such equivalent point or location of the movable arm is set at over the fixed arm at a space at least say “s” away from the fixed way linking point, the spaces s and d are so set, that a space equal to s+d is at least not less than the space that could be provided to the unit body diametrically opposite side of the operating end to accommodate the thumb comfortably; to support comfortable operation of the movable arm; while the distance “s” is at least 0.5 cm to support towards availing or improving mechanical advantage; the pivoting point or such equivalent point or location is set at the movable arm maintaining a ratio a:b at a value so that adequate mechanical advantage can be availed for easy and comfortable operation, where “a” is the distance from the pivoting point or such equivalent point or location to the operating end, more particularly to the effective operating force exerting point and “b” is the distance from the pivoting point or such equivalent point or location to the clipping end, more particularly to the gripping force exerting point or contacting point

7. A slender formed unit body stated in claim 1 and any of the preceding claims according to this invention wherein movable arm is incorporated over the fixed arm pivotally by means of a pivoting arrangement by hinging, by providing aligned holes to the fixed arm and movable arm creating side collars and extensions to it as needed and by incorporating headed pin or tight fitting pin or spring bar through the holes; the fixed arm is an added component incorporated to the unit body integrally or in assembled part.

8. A slender formed unit body stated in claim 1 and any of the preceding claims according to this invention wherein the spring arrangement is incorporated to the clip assembly by incorporating a spring, preferably a flat formed elongated spring, preferably with corrugation made longitudinally; the said flat formed elongated spring is curved as needed to facilitate its clamping or securing one of its end to the free end of the fixed arm or at a part of the fixed arm and touch set or securing its other end part at the movable arm at appropriate location to press up the operating end of the movable arm, and thereby to press down the clipping end of the movable end and vice versa to develop gripping pressure during non operating state and to exert pressure to auto let down of the clipping head upon releasing the pressure from the operating end; the elongated formed spring is any one of the shapes like “U” shaped with one of its legs extended and divergent way bent, “S” shaped with one of its curves convergent way bent, “U” shaped with its legs convergent way bent, “U” shaped with its legs divergent way bent.

9. A slender formed unit body stated in claim 1 and any of the preceding claims according to this invention wherein the spring arrangement incorporated to the clip assembly is made by incorporating a spring, preferably a flat “U” shaped spring with one of its legs extended and divergent way bent formed, clamping the spring by securing the “U” curve of the spring round the free end of the fixed arm and shaping the other extended leg, so that its extended end part touches through a contacting area and exert upward pressure to the operating end side of the movable arm, thereby exert gripping pressure through the clipping head.

10. A slender formed unit body stated in claim 1 and any of the preceding claims according to this invention wherein movable arm incorporated over the fixed arm pivotally by means of an arrangement equivalent to pivoting arrangement by incorporating aligned short cylindrical projections to the side surfaces or to the incorporated collars of the movable arm and making co-operating grooves or holes to the side surfaces or to the incorporated collars of fixed arm or vice versa, and by coupling the arms by coupling the co-operating pairs.

11. A slender formed unit body stated in claim 1 and any of the preceding claims according to this invention wherein the movable arm incorporated over the fixed arm pivotally by means of an arrangement equivalent to pivoting arrangement according to an another feature of this invention by incorporating “S” formed one curve convergent way biased flat formed spring to the clip assembly, clamping the other curve side to the fixed arm by rounding through free end of the of the fixed arm, and securing the other convergent way biased side to the movable arm, by tabbing method or by slot securing with arrestor, or by riveting and like.

12. A slender formed unit body stated in claim 1 and any of the preceding claims according to this invention wherein the movable arm incorporated over the fixed arm pivotally by means of an arrangement equivalent to pivoting arrangement according to a still another feature of this invention wherein a convergent way biased “U” formed spring is incorporated to the clip assembly, securing its one leg side to the free end side of the fixed arm, and securing the other leg to the movable arm, securing is done by tabbing method or by slot securing with arrestor, or by riveting and like.

13. A slender formed unit body stated in claim 1 and any of the preceding claims according to this invention wherein arrangement equivalent to pivoting arrangement and elastically biasing arrangement equivalent to incorporation of spring is simultaneously done by making the fixed arm and the movable arm with rigidity improving cross sections like “I” section, channel “[” section and like and linking the fixed arm and the movable arm at pivoting position or location making the linking portion with rigidity reducing or flexibility improving cross sections like corner rounded off rectangular cross section, or circular “O” cross section or elliptical cross section and like; even “I” section and like with reduced cross sectional area would serve to reduce rigidity, that is to improve flexibility, to make the arrangements production co-operating, particularly to make it molding co-operating and component minimizing.

14. A slender formed unit body stated in claim 1 and any of the preceding claims according to this invention wherein the length space of the entry passage between the clip assembly and the unit body for entry of pocket flap or other anchoring object is almost equal to the effective length space of an equivalent clip, taking equivalent clip is a clip of pen of length space equal to the space of the clip assembly measured from clipping end containing vertical plane to the end of the fixed end of the fixed arm, and the effective length space of equivalent clip is the said length space of equivalent clip less the length of the linking portion through which the clip is linked to the unit body.

15. A slender formed unit body stated in claim 1 and any of the preceding claims according to this invention wherein to make the clip more slide resisting, to prevent easy fall out of the pen; the clipping head is made with relatively wider area or roughened or friction creating material like rubber incorporated.

16. A slender formed unit body stated in claim 1 and any of the preceding claims according to this invention wherein to accomplish interlocking of the pen with the pocket flap, the arrangement of press ejecting pin is made by securing non pointed end of a pointed pin almost perpendicularly to the body facing side of the movable arm at near its clipping head incorporated end or at a created base of the clipping head within a created assembly of the clipping head, the pin is arranged to pass through a co-operating hole made through the clipping head or its assembly separating the pin securing face and the clipping head or the integrated part containing the pressuring face of the clipping head by a cushioning material like spring, sponge and like, and set so that the pointed end of the pin eject out when the clip head press the body or its cap, a co-operating hole or grove is made to the elongated formed unit body or to the cap where the ejected pin can enter to accomplish the interlocking.
